(19) United States
(12) Patent Application Publication
(10) Pub. No.: US 2007/0009270 A1
(43) Pub. Date: Jan. 11, 2007

(54) Image forming apparatus, sheet feeding device, image forming system, and sheet finisher

(76) Inventors: Masanobu Kawano, Toyokawa-shi (JP); Eiji Sugimoto, Tokyo (JP)

Correspondence Address: CANTOR COLBURN, LLP, 55 GRIFFIN ROAD SOUTH, BLOOMFIELD, CT, 06002, US

(21) Appl. No.: 11/440,304

(22) Filed: May 24, 2006

(30) Foreign Application Priority Data
Jul. 8, 2005 (JP) JP2005-199850
Apr. 17, 2006 (JP) JP2006-113077

(51) Int. Cl. G03G 15/00

(52) U.S. Cl. 399/13

(57) ABSTRACT

An image forming apparatus includes an image forming section to form images, a sheet feeding section to feed sheets to the image forming section, a sheet ejection section to supply sheets to the connected sheet finisher, a communication section to communicate with the connected sheet finisher, and a controller to control the image forming section and the sheet feeding section. Setting information of the sheet finisher contains sheet distance information between a preceding sheet and a following sheet thereof and sheet conveyance speed information and the controller receives the setting information from the sheet finisher via the communication section and controls the image forming section, the sheet feeding section and the sheet ejection section according to the setting information.

This application is based on Japanese Patent Application Nos. 2005-199850 filed on Jul. 8, 2005 and 2006-113077 filed on Apr. 17, 2006, which are incorporated hereinto by reference.

### BACKGROUND OF THE INVENTION

This invention relates to an image forming apparatus, sheet feeding device, image forming system or sheet finishing system.

Conventionally, various kinds of electro-photographic image forming apparatus have been well known such as copying machines, printers, and facsimiles. It has been proposed that such an image forming apparatus is followed by a sheet finisher to form an image processing system as a whole. Such an image forming system performs post-processing such as stapling, punching, and folding on sheets on which images for each job are formed by the image forming apparatus.

In addition to the above, the sheet finisher can be connected to a sheet feeding device that stores and supplies a lot of sheets and build up a sheet finishing system.

Such image forming systems and sheet finishing systems have been distributed respectively including an image forming apparatus, a sheet feeding device, and a sheet finisher that have been developed and manufactured simultaneously.

Recently, customers' diversified requirements for image forming systems have been increasing so quickly. Therefore, immediately after an image forming apparatus, a sheet finisher, and a sheet feeding device are released, another image forming apparatus, sheet finisher, and sheet feeding device of brand-new functions are separately developed, manufactured, and released. As the result, customers will want to use brand-new functions by connecting such new image forming apparatus, sheet finisher, and/or sheet feeding device to their existing image forming systems.

However, as described above, the conventional image forming systems assume that their image forming apparatus, sheet finishers and sheet feeding devices are developed, manufactured, and released simultaneously and that the image forming systems will be equipped with no additional unit such as an image forming apparatus, a sheet feeding device and a sheet finisher, that is developed and manufactured separately. For example, a conventional image forming apparatus pre-installs a control program capable of controlling a sheet feeding device and a sheet finisher which are designed to be connected to the image forming apparatus.

Therefore, when a new sheet finisher or a sheet feeding device, for example, is connected to an existing image forming system, the image forming apparatus must substitute the existing control program by a new control program which is designed to control the new sheet finisher and sheet feeding device so that the image forming apparatus can work together with the new sheet finisher and sheet feeding device. In other words, the user cannot use the existing image forming system immediately after connecting a new sheet finisher or a sheet feeding device is connected to the existing image forming system. The control program of the image forming system must be updated and a service engineer or sales person of the image forming apparatus must be called for updating. This is time-consuming and inconvenient to the user.

To solve the above problem, some kinds of technologies have been proposed. One of the technologies is disclosed for example, by Patent Document 1 (Japanese Non-Examined Patent Publication H09-194129). This is a sheet finishing system which contains, for example, a sheet finisher, an image forming apparatus, and a card reader wherein sheet distance information stored in a card is set in the card reader by the operator and sent to the image forming apparatus, and the image forming apparatus causes a sheet distance controller to feed sheets at predetermined intervals according to the sheet distance information of the card.

However, the system of Patent Document 1 requires a card reader and a card which stores sheet distance information beforehand. Therefore, the card is complicated in structure. If the card is lost or card reading is omitted, the image forming apparatus cannot use the system or it takes a time to restart the system.

A technology of Patent Document 2 (Japanese Non-Examined Patent Publication H11-208979) controls sheet feeding intervals by receiving a required sheet setting time from the sheet finisher, recognizing thereof, and controlling the sheet feeding intervals according to the setting time, and changes the sheet ejection intervals from the image forming apparatus. This technology increases the productivity of the whole system by utilizing the productivity of the high-productivity image forming apparatus.

A technology of Patent Document 3 (Japanese Non-Examined Patent Publication 2003-40521) is designed to maximize the productivities of the image forming apparatus and the sheet finisher by leaving the control of sheet finishing conditions to the sheet finisher, causing the image forming apparatus to send required sheet finishing information to the sheet finisher, causing the sheet finisher to calculate a sheet finishing time and send the result to the image forming apparatus, and causing the image forming apparatus to control the sheet conveyance timing and change the sheet feeding interval.

A technology of Patent Document 4 (Japanese Non-Examined Patent Publication 2005-170628) increases the productivity of the system by causing the sheet finisher to send control data to the image forming apparatus to change the timing to feed sheets from the image forming apparatus to the sheet finisher according to the control data.

The technologies of Patent Documents 1, 2 and 3 control the intervals of sending sheets to the sheet finisher singly by controlling the sheet conveyance distance according to the processing time of the sheet finisher. Therefore, if the sheet conveyance speed of the image forming apparatus is not equal to that of the sheet finisher, the system may have some kinds of sheet conveyance problems such as paper jamming.

### SUMMARY OF THE INVENTION

In consideration of the above problems, an object of this invention is to provide an image forming system which conveys sheets from its sheet feeding device, image forming apparatus, and image forming apparatus to its sheet finisher, and a sheet finishing system which conveys sheets from the sheet feeding device to the sheet finisher, wherein the image forming system does not require installation of a new control software even when sheet information of the sheet finisher has not been stored in the sheet feeding device and the image forming apparatus or when the sheet finisher, the sheet feeding device, and the image forming apparatus have different sheet conveyance speeds; manual input of sheet information of the sheet finisher by the operator after the sheet finisher is connected to the image forming apparatus or to the sheet feeding device, and is easy to run together without being apprehensive that a memory medium may be lost.

The above object of this invention can be achieved by the following.

(1) An image forming apparatus comprising an image forming section to form images, a sheet feeding section to feed sheets to the image forming section, a sheet ejection section to supply sheets to the connected sheet finisher, a communication section C1 to communicate with the connected sheet finisher, and a controller A to control the image forming section and the sheet feeding section, wherein setting information of the sheet finisher contains sheet distance information between a preceding sheet and a following sheet thereof and sheet conveyance speed information and the controller A receives the setting information from the sheet finisher via the communication section C1 and controls the image forming section, the sheet feeding section and the sheet ejection section according to the setting information.

(2) An image forming system comprising an image forming apparatus to form images on sheets and a sheet finisher to finish sheets on which images are formed by the image forming apparatus, wherein the image forming apparatus is equipped with an image forming section to form images, a sheet feeding section to feed sheets to the image forming section, a sheet ejection section to supply sheets to the connected sheet finisher, a communication section C1 to communicate with the connected sheet finisher, and a controller A to control the image forming section and the sheet feeding section; the sheet finisher is equipped with a communication section C2 to communicate with the image forming apparatus in connection and setting information to control the sheet finisher; the setting information of the sheet finisher contains sheet distance information between a preceding sheet and a following sheet thereof and sheet conveyance speed information; and the controller A receives setting information of the sheet finisher from the communication section C2 of the sheet finisher via the communication section C1 and controls the image forming section, the sheet feeding section, and the sheet ejection section.

(3) A sheet feeding device comprising a stacking section to stack sheets, sheet feeding rollers to feed sheets one by one from the stacking section, a conveyance section to feed sheets to a sheet finisher which is connected to the conveyance section, a communication section C3 to receive sheet-related setting information of the sheet finisher, and a controller C to control the sheet feeding device, wherein the setting information contains sheet distance information between a preceding sheet and a following sheet thereof and sheet conveyance speed information of the sheet finisher; and the controller C controls the conveyance section according to the setting information.

(4) A sheet finishing system comprising a sheet feeding device to feed sheets and a sheet finisher to receive sheets from the sheet feeding device and finish the sheets, wherein the sheet feeding device is equipped with a stacking section to stack sheets, sheet feeding rollers to receive sheets from the stacking section and send sheets one by one to a sheet finisher which is connected thereto, a conveyance section B to send sheets to the sheet finisher, a communication section C3 to receive sheet-related setting information of the sheet finisher, and a controller C to control the sheet feeding device; the setting information contains sheet distance information between a preceding sheet and a following sheet thereof and sheet conveyance speed information of the sheet finisher; and the controller C controls the conveyance section according to the setting information.

### BRIEF DESCRIPTION OF THE DRAWINGS

FIG. 1 is a sectional view of an image forming apparatus which is an embodiment of this invention;

FIG. 2 is a sectional view of an example of sheet finisher which is connected to an image forming apparatus or a sheet feeding device;

FIG. 3 is a sectional view of an example of sheet feeding device;

FIG. 4 is an explanatory view of an example of image forming system which contains an image forming apparatus connected to a sheet finisher;

FIG. 5 is a block diagram of an example of image forming system which contains an image forming apparatus connected to a sheet finisher;

Each of FIGS. 6(a)-6(b) shows an example of control flow of an image forming system which contains image forming apparatus 1 connected to sheet finisher 8;

FIG. 7 shows an example of control flow using setting information of sheet finisher 8 in image forming apparatus 1;

FIG. 8 is an explanatory view of an example of a sheet finishing system in which a sheet feeding device is connected to the sheet finisher;

FIG. 9 is a block diagram of an example of sheet finishing system in which a sheet feeding device is connected to the sheet finisher;

Each of FIGS. 10(a)-10(b) shows an example of control flow of a sheet finishing system in which a sheet feeding device is connected to the sheet finisher; and

FIG. 11 shows a control flow of the sheet feeding device 9 according to setting information of the sheet finisher.

### DETAILED DESCRIPTION OF THE PREFERRED EMBODIMENT

Below, there will be explained preferred embodiments of this invention. It is to be understood that the description below does not limit the technical ranges and terms of the claims.

Conventionally, as described above, when a component of an existing image forming system such as an image forming apparatus, a sheet feeding device, or a sheet finisher is for example renewed or reconnected, a control program must be created and installed to run the system successfully together with the new component. To solve this problem, the inventors found a technology of causing the sheet finisher to store setting information pertaining to cooperation of the sheet finisher with the sheet feeding device and the image forming apparatus, automatically sending the setting information from the sheet finisher in the downstream side to the sheet feeding device or the image forming apparatus in the upstream side when the sheet finisher is reconnected to the image forming apparatus or the sheet feeding device, and controlling the sheet feeding device or the image forming apparatus by the cooperation-related setting information. With this technology the user can start the image forming system immediately after reconnecting the sheet finisher to the sheet feeding device or image forming apparatus.

First, there will be explained the configuration and operation of the image forming apparatus of this invention assuming that the image forming system contains a sheet finisher in the downstream side of the image forming apparatus. The sheet-related information of the sheet finisher is also called setting information of the sheet finisher.

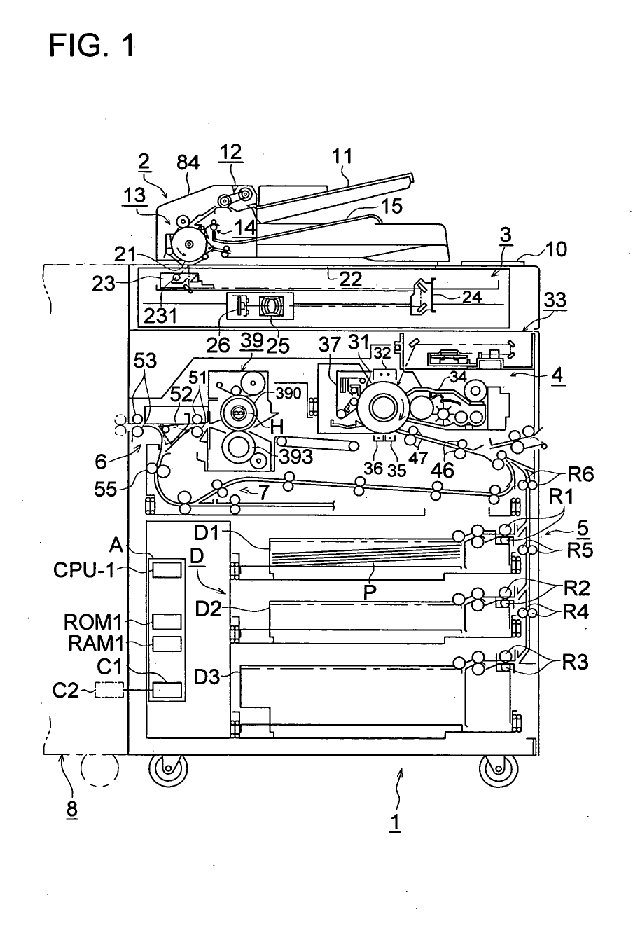

FIG. 1 is a sectional view of an image forming apparatus which is an embodiment of this invention.

Image forming apparatus 1 is equipped with automatic document feeder 2 which takes up each document from a document stack, conveys it to a reading position, and ejects it after reading, image reader 3 which reads image of document in the reading position, image forming section 4 which forms toner images according to image data sent from image reader 3, sheet feeding section D which takes up each sheet of a selected size from sheet trays and feeds it to conveyance section 5, conveyance section 5 which passes the sheet from sheet feeding section D to a toner image transfer position, fixing device 39 which fixes toner image to the sheet, sheet ejection section 6 which ejects the image-fixed sheet, reverse conveyance section 7 which reverses sheet and conveys it back to the transfer position, operation panel 10 equipped with a touch-panel and switches to enable operators to enter image forming conditions and display data and information, and controller A which controls the above components.

Controller A is equipped with central processing unit CPU-1, read-only memory ROM1 which stores an image formation control program, a communication control-related program, and others, random-access memory RAM1 which is rewritable, and communication section C1 which communicates with sheet finisher 8. Controller A controls the above components.

Next, there will be explained the operation of this invention. When the operator sets job-related information such as a sheet size, the number of sheets to be processed, and sheet finishing information from operation panel 10 and enters a job start instruction, image forming apparatus 1 starts. Then, documents on document table 11 are automatically separated one by one by document feeder 2 and conveyed to the reading position by document conveyance section 13.

The document reading position is provided in the downstream side of document conveyance section 13 along the movement of sheets and a document image is read through slit 21 of image reader 3.

After being read, the document is ejected to document ejection tray 15 by document sheet ejection section 14.

It is also possible to place a document directly on platen glass 22 and read it.

Image reader 3 is equipped with lamp 231 which illuminates a document through slit 21, first mirror unit 23 which receives light from the document and reflects it, second mirror unit 24, imaging lens 25 to focus the reflected light to an image pickup element (CCD 26), and linear CCD 26 which performs a photoelectric conversion to a light image focused by the imaging lens 25.

The resulting analog signal of the document image output from CCD 26 is converted into a digital signal after analog-to-digital conversion and sent to an image processing section. The image processing section performs shading correction, filter processing and γ correction on the digital signal into image data and temporarily stores the image data in memory.

Image forming section 4 forming an image electro-photographically is equipped with drum-shaped photoreceptor 31 coated with a photoconductive photosensitive layer, charger 32 which uniformly charges the surface of photoreceptor 31, laser writer 33 which is operated according to processed image data to apply light to the surface of photoreceptor 31 and form an electrostatic latent image thereon, developing section 34 which develops the electrostatic latent image into a visible toner image on the surface of photoreceptor 31, transfer electrode 35 to transfer the visible toner image to a sheet, charge neutralizer 36 which applies A.C. corona to the back side of the sheet having the visible toner image to separate the sheet from the surface of photoreceptor 31, and cleaning section 3 to clean the surface of photoreceptor 31 after transferring.

Fixing device 39 is equipped with upper fixing roller 390 which houses heating source H and lower fixing roller 393 which is pressed against upper fixing roller 390 to rotate together. Fixing ejection rollers 51 and sheet ejection section 6 are provided in the downstream side of fixing device 39 along the movement of sheets. Sheet ejection section 6 is equipped with switching member 52, reverse rollers 55, and sheet ejection rollers 53 which ejects sheets outside the apparatus.

The image formation on a sheet by image forming section 4 and fixing device 39 is accomplished by the steps of causing charger 32 to charge photoreceptor 31 which is driven to rotate in the arrow direction by a driving source, causing laser writer 33 to apply dot exposure to the surface of photoreceptor 31 to form an electrostatic latent image corresponding to image data thereon, causing developing section 34 to turn the electrostatic latent image into a visible toner image, causing registration rollers 46 to convey sheet P, causing transfer electrode 35 to transfer the toner image to the sheet, and causing fixing device 39 to fix the toner image on the sheet.

Sheet feeding section D equipped with sheet trays D1 to D3 picks up and feeds a sheet of a selected size from the sheet trays according to job-related information by conveyance rollers R1, R2, R3, R4, and R5.

Conveyance section 5 equipped with conveyance rollers R6, registration rollers 46, and pre-transfer rollers 47 receives sheet P from sheet feeding section D and convey it to image forming section 4.

Sheet ejection section 6 ejects sheet P directly over switching member 52 or reversed by reverse rollers 55 below switching member 52. In single-sided image forming mode, sheet P ejected from fixing and ejection rollers 51 are ejected directly over switching member 52 or reversed by reverse rollers 55 and sent to sheet finisher 8. In double-sided image forming mode, sheet P is sent to reverse conveyance section 7 through under switching member 52.

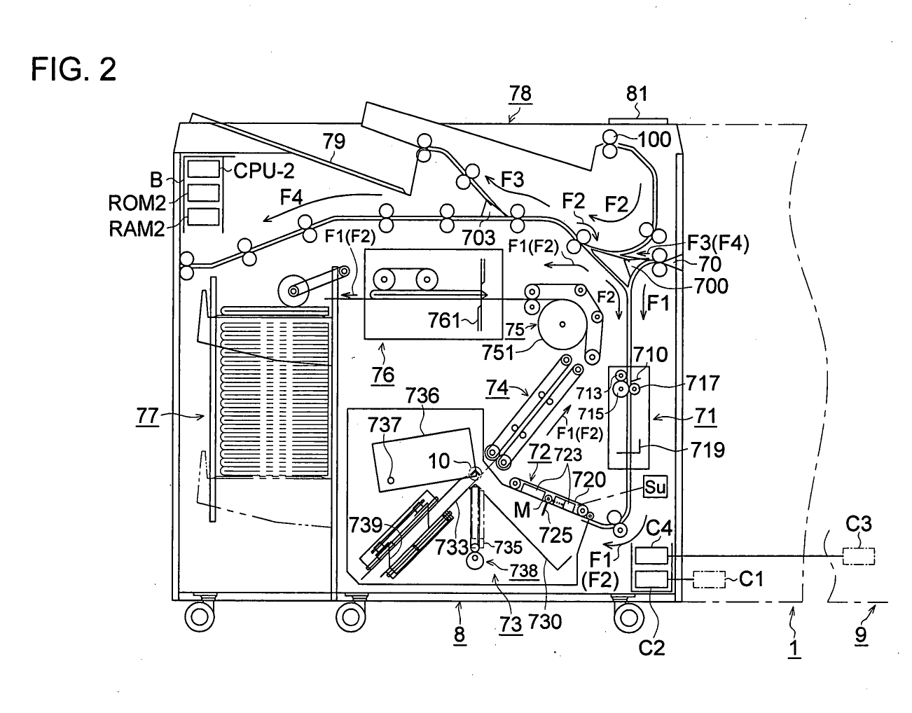

FIG. 2 is a sectional view of an example of sheet finisher which is connected to image forming apparatus 1 or sheet feeding device 9.

Below, there will be explained the configuration and operation of a sheet finisher which is connected to the image forming apparatus with reference to FIG. 2.

Sheet finisher 8 is equipped with sheet inlet 70 to receive sheet P which is ejected by sheet ejection rollers 53 from image forming apparatus 1, center-folding section 71 which is provided in the sheet conveyance path to fold sheets for folding at the center thereof, first conveyance section 72 to suction-convey each sheet, center-stapling section 73 to staple sheets at the center thereof, second conveyance section 74 which is made of one pair of belts to convey sheets, third conveyance section 75 which is made of rollers and belts to convey sheets, cutting section 76 which trims sheets by a cutter, stacking section 77 to stack sheets, cover sheet feeder 78 to feed cover sheets, tray 79 to stack sheets thereon, and sheet finisher controller B to control the above sections.

Arrows F1, F2, F3, and F4 represent four sheet conveyance paths. Sheet path F1 is to convey sheets by center-stapling commands. Sheet path F2 is to convey cover sheets for a stack of sheets which are conveyed through the sheet path F1 and stacked in center-stapling section 73. Sheet path F3 is to convey sheets which need not be stapled at the center to tray 79. Sheet path F4 is to convey sheets to be finished by another sheet finisher which is used together with the current sheet finisher. These sheet paths contain a lot of conveyance roller along them.

Switching section 700 switches between sheet paths F1 and F3 to guide sheets. Switching section 703 switches between sheet paths F3 and F4 to guide sheets.

Center-folding section 71 in the sheet path F1 is equipped with film- or knife-shaped pushing member 710 provided to push a sheet perpendicularly to the movement of the sheet, upper roller 713 and lower roller 715 to clamp the sheet which is pushed in by pushing member 710, conveyance roller 717 which is pressed against lower roller 715 and rotates together to deliver the sheet in the preset direction, and stopper 719 which is provided in the downstream side of the rollers and can be moved to and from the sheet path.

Stopper 719 is inserted into a position in the sheet path which is equivalent to half of the sheet size along the movement of the sheet away from the nip position in the vertical direction between upper roller 713 and lower roller 715. When the leading edge of a sheet coming from sheet inlet 70 reaches stopper 719, the rollers stop rotating clockwise.

Next, pushing member 710 pushes the sheet into the space between upper roller 713 and lower roller 715 to give the sheet a fold perpendicular to the movement of the sheet. The rollers restart to rotate again clockwise to convey the sheet to center-stapling section 73.

First conveyance section 72 is equipped with a punched rotary belt 720 having a lot of holes and a suction box 723 which is provided inside the loop of rotary belt 720 and connected to suction unit Su via a duct.

Rotary separator 725 made of wires or the like beats the leading part of a sheet which is delivered while being sucked to the lower surface of rotary belt 720 from inside the loop of rotary belt 720 (or from the upper side in the figure) to separate the sheet from the belt. Motor M works to drive separator 725.

Center-stapling section 73 is equipped with a stacking section which stacks sheets delivered via first conveyance section 72. The stacking section is equipped with first stacking section 730 in the upstream side and second stacking section 733 in the downstream side.

First stacking section 730 and second stacking section 733 are made of plates which are respectively tilted at approximately 45 degrees to the vertical plane. The stacking section is angled and there is a clearance between the top ends of the stacking sections.

Further, the central section which is divided in the depth direction of second stacking section 733 is designed to reciprocate by a preset distance between the illustrated position and the diagonal upper right.

This is to apply the central section to the fold of center-folded sheets to form a booklet of sheets and push the booklet into the space between belts of second conveyance section 74.

Staple receiving section 735 is provided in the central position between first stacking section 730 and second stacking section 733 so that it can move in the depth direction (or in the direction perpendicular to the page). One part of the top of staple receiving section 735 faces to the clearance between the top ends of both stacking sections.

Above staple receiving section 735, stapling sections 736 are provided at a predetermined interval so as to swing around axis 737 and move in the depth direction.

Stapling sections 736 and staple receiving section 735 constitute a stapler which can staple up to 100 sheets. Two staplers are provided at an appropriate interval along the depth direction.

A two-folded booklet of up to 100 sheets can be formed by positioning each sheet by first stacking section 730, second stacking section 733, and sheet stopper 739 to detect the leading edge of the sheet, aligning folds of sheets by aligning section 738, and driving stapling section 736 and staple receiving section 735.

The sheet finisher with other well-known structures can correct sheet curls, punch and sort sheets.

With the above configuration, the sheet bundle which has been finished with-the center-stapling is pushed upper right by second stacking section 733, gradually formed into a booklet, delivered to second conveyance section 74, turned over by second conveyance section and third conveyance section 75, cut off excessive edges by cutting section 76, and ejected to stacking section 77.

Stacking section 77 can move down to stack sheets as the sheets on the section increase, and can stack a predetermined amount of sheets thereon.

Controller B of sheet finisher 8 contains CPU-2, ROM2 which stores programs such as a sheet finisher control program and a communication control program, communication section C2 to communicate with image forming apparatus 1, and communication section C4 to communicate with sheet feeding device 9. Controller B controls the above components.

ROM2 retains setting information of the sheet finisher. The setting information contains sheet distance information about an interval of sheets between a preceding sheet and a following sheet thereof to be conveyed, conveyance speed information about speeds at which sheets are conveyed in the sheet finisher, maximum sheet number information about the maximum number of sheets in stack to be finished by the sheet finisher, and maximum sheet size information about maximum sheet sizes which can be finished by the sheet finisher.

Communication section C2 of sheet finisher 8 is connected to communication section C1 of image forming apparatus 1, causes controller B to read setting information of the sheet finisher such as sheet distance information, conveyance speed information, maximum sheet number information, and maximum sheet size information from ROM2 upon request of image forming apparatus to send the setting information, and sends it to controller A via communication sections C2 and C1.

Communication section C4 of sheet finisher 8 is connected to communication section C3 of sheet feeding device 9, causes controller B to read setting information of the sheet finisher such as sheet distance information, conveyance speed information, maximum sheet number information, and maximum sheet size information from ROM2 upon request of sheet feeding device 9 to send the setting information of the sheet finisher, and sends it to controller C via communication sections C4 and C3.

Communication sections C1, C2, C3, and C4 are automatically selected and connected by a connector when sheet finisher 8 is connected to image forming apparatus 1 or when sheet finisher 8 is connected to sheet feeding device 9.

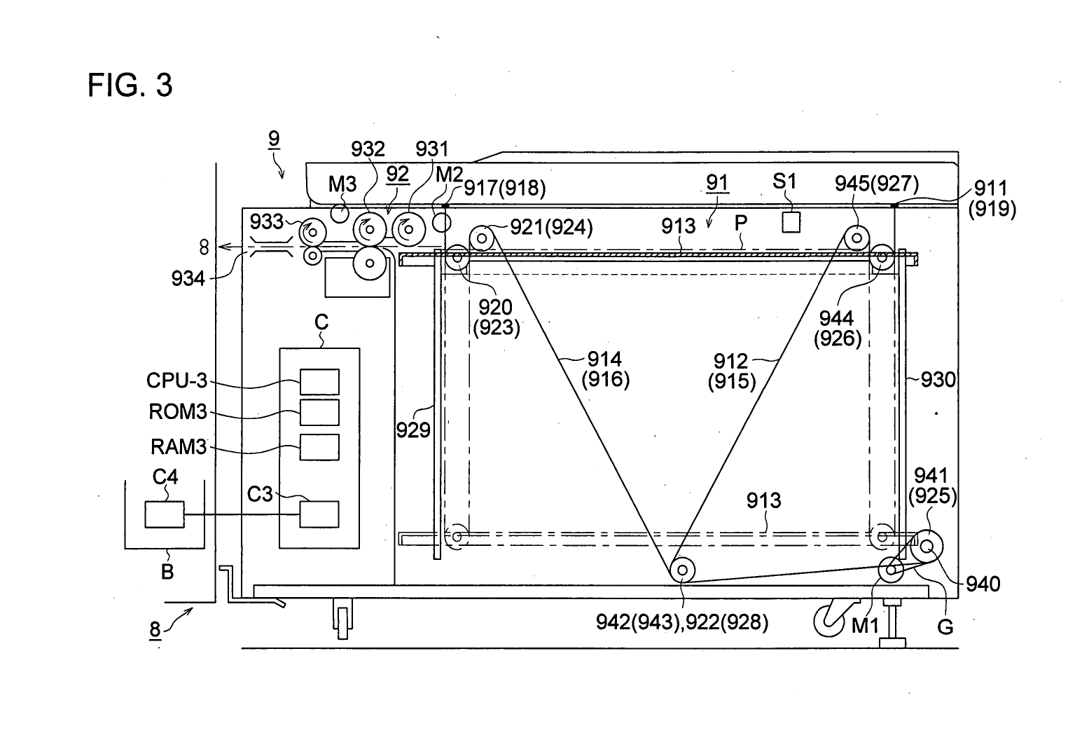

FIG. 3 is a sectional view of an example of sheet feeding device 9.

Below, there will be explained the configuration and operation of sheet feeding device 9 which can be mounted on and demounted from sheet finisher 8 with reference to FIG. 3.

FIG. 3 shows sheet stacking tray 913 constituting a part of stacking section 91, with sheets P which can move up and down and particularly sheet stacking tray 913 near the upper limit position. Sheet stacking tray 913 has sheets P on it.

First, there will be explained the movement of sheet stacking tray 913. Each of one end of four lifting wires 914, 916, 912, and 915 which are provided respectively in the front and the rear of the figure, is engaged respectively with each of the engaging section 917, 918, 911, and 919 on the upper part of sheet feeding device 9 and each of the other end is fixed on lift driving shaft 940. Each of moving pulley 920, 923, 944, and 926 is hung by each of wires between the one end and the other end of each wire, and sheet stacking tray 913 is fixed to moving pulleys.

By rotating the lift driving shaft 940 forward or backward, sheet stacking tray 913 can move up and down.

In details, lifting wire 914 (or 916) one end of which is connected to engaging section 917 (or 918) rotates moving pulley 920 (or 923) mounted in the downstream side of sheet stacking tray 913 along the movement of sheets and rotates pulley 921 (or 924) and pulley 942 (or 943) provided on the sheet feeding device and pulley 941 (or 925) which is provided on one end of lift driving shaft 940, and is engaged with lift driving shaft 940. Lifting wire 912 or 915 one end of which is connected to engaging section 911 (or 919) rotates moving pulley 944 (or 926) in the upstream side of sheet stacking tray 913 along the movement of sheets, rotates pulley 945 (or 927) and pulley 922 (or 928) provided on the sheet feeding device and pulley 941 (or 925) provided on one end of lift driving shaft 940, and is engaged with lift driving shaft 940.

Lift driving shaft 940 supported on the sheet feeding device is driven by motor M1 through drive transmission belt G. Lift driving shaft 940 is rotated forward and backward by the forward and backward rotation of motor M1.

As lift driving shaft 940 rotates, lifting wires 914, 916, 912, and 915 are taken up through pulleys 941 and 925 mounted on lift driving shaft 940.

Lifting wires 914, 916, 912, and 915 whose ends are fixed to engaging sections 917, 918, 911, and 919 rotate pulleys 921, 924, 945, and 927 (942, 943, 922, and 928) to move up intermediate moving pulleys 920, 923, 944, and 926. The distance of each moving pulley is equal to ½ of the distance of each lifting wire. Therefore, sheet stacking tray 913 having moving pulleys 920, 923, 944, and 926 at four corners thereof moves up and down at ½ of the distance of each lifting wire and at ½ of the speed.

Sheet stacking tray 913 is guided by guide grooves 929 and 930 to move up vertically.

The dot-dashed lines indicate sheet stacking tray 913 near the lower limit position.

Controller C of sheet feeding device 9 detects the top of sheet stacking tray 913 or the uppermost surface of sheets stacked on the sheet stacking tray by sheet sensor S1 and controls the operation of motor M1 so that the uppermost surface of the sheets stacked comes to the bottom surface position of sheet feeding roller 931.

Controller C drives motor M2 at a predetermined timing to rotate sheet feeding roller 931 in the arrow direction and feed sheets one by one from the top sheet. The conveyance section 92 to convey each sheet fed is equipped with registration roller 932 and sheet ejection roller 933.

At a predetermined timing, motor M3 drives registration roller 932 and sheet ejection roller 933 in the arrow direction to convey the fed sheet at a predetermined timing and speed which is equal to the conveyance speed of the sheet finisher. The sheet is ejected from outlet 934 of sheet feeding device 9 and fed into sheet finisher 8 in the downstream side.

Controller C of sheet feeding device 9 is equipped with CPU-3, ROM3 which stores a sheet feeding program, RAM3, and communication section C3 to communicate with sheet finisher 8.

Communication section C3 of sheet feeding device 9 is connected to communication section C4 of sheet finisher 8. Controller C of sheet feeding device 9 sends a request to controller B of sheet finisher 8 via communication section C3 and C4 to send setting information of the sheet finisher. When receiving the setting information of sheet finisher 8 such as information of a sheet distance between a preceding sheet and a following sheet thereof, conveyance speed information, maximum sheet number information, and maximum sheet size information from controller B, controller C stores it in ROM3.

Controller C of sheet feeding device 9 controls motor M2 by the sheet distance information so that sheets may be conveyed by sheet feeding roller 931 at preset interval and conveyance speed. Controller C controls motor M3 by the sheet distance information and the conveyance speed information to adjust the sheet conveyance timing and speed of registration roller 932 and sheet ejection roller 933. As the result, sheets are conveyed from outlet 934 to sheet finisher 8 at sheet distance and conveyance speed specified by sheet distance information and conveyance speed information of sheet finisher 8, which is equal to the sheet conveyance speed of the sheet finisher.

Controller C checks the size of sheets stored in sheet feeding device 9 according to maximum sheet quantity information and maximum sheet size information. If the size is greater than the maximum sheet size information, controller C outputs a size error alarm and stops feeding sheets until the error is reset.

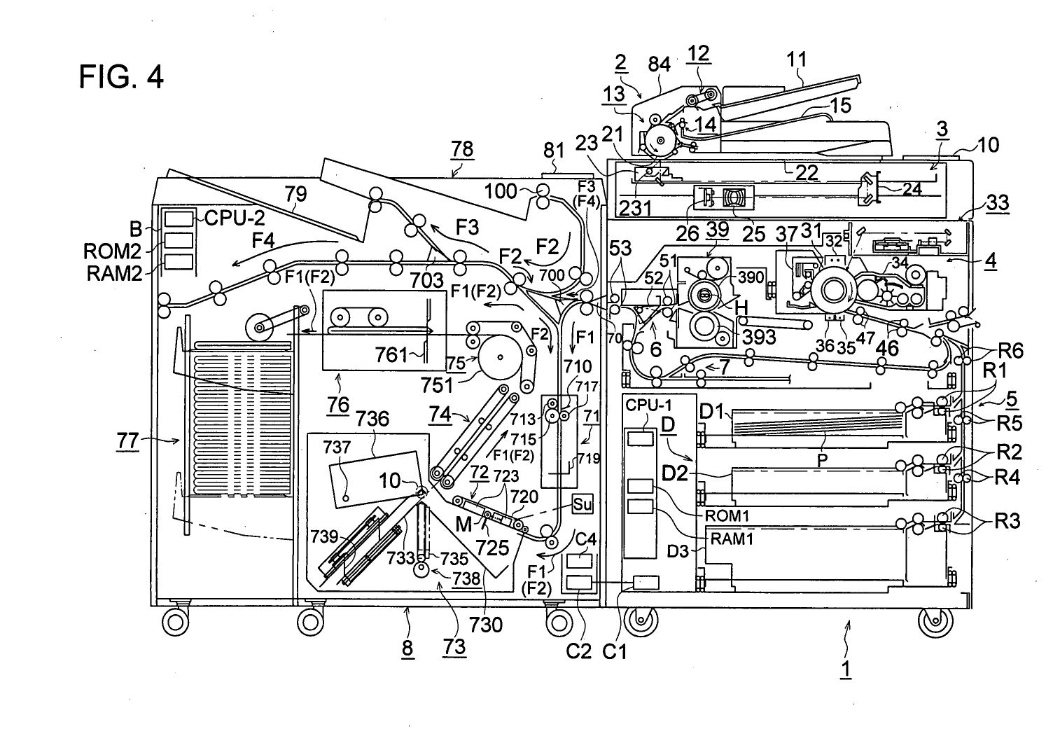

FIG. 4 is an explanatory view of an example of image forming system which contains image forming apparatus 1 connected to sheet finisher 8.

Below, there will be explained an image forming system equipped with image forming apparatus 1 and sheet finisher 8 which work together to deliver sheets from image forming apparatus 1 to sheet finisher 8.

Image forming apparatus 1 and sheet finisher 8 of FIG. 4 are the same as those of FIG. 1 and FIG. 2 and their detailed explanation is omitted here.

Image forming apparatus 1 and sheet finisher 8 are connected to perform operations related to the above-described image formation and sheet finishing.

First, when the operator sets job-related information such as a sheet size, the number of sheets to be processed, and a sheet finishing type from operation panel 10 of image forming apparatus 1, the information is sent to controller B of sheet finisher 8 from communication section C1 via communication section C2. According to the job-related information, controller B performs, for example, positions stopper 719 for a selected sheet size, loads and stops loading the requested number of sheets on tray 79 and stacking section 77, changes sheet paths F1, F2, F3, and F4 by switching section 700 according to the specified sheet finishing type, and turns on or off center-folding unit 71, center-stapling section 73 and cutting section 76 to perform the specified sheet finishing.

Further, for example, when image forming apparatus 1 is powered on, controller A sends a request to controller B via communication section C1 and communication section C2 to send setting information of the sheet finisher to controller A. When controller A receives setting information, image forming apparatus 1 can acquire the setting information of sheet finisher 8 which is newly connected.

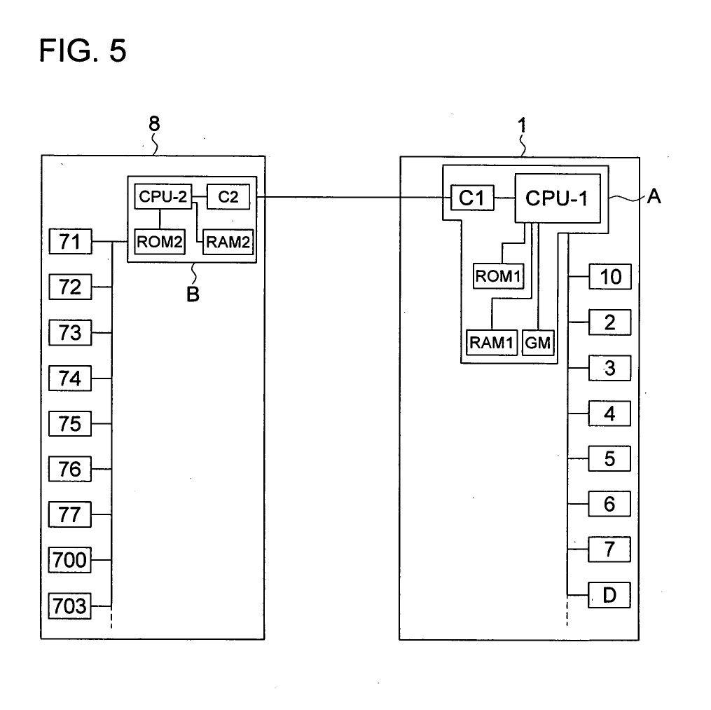

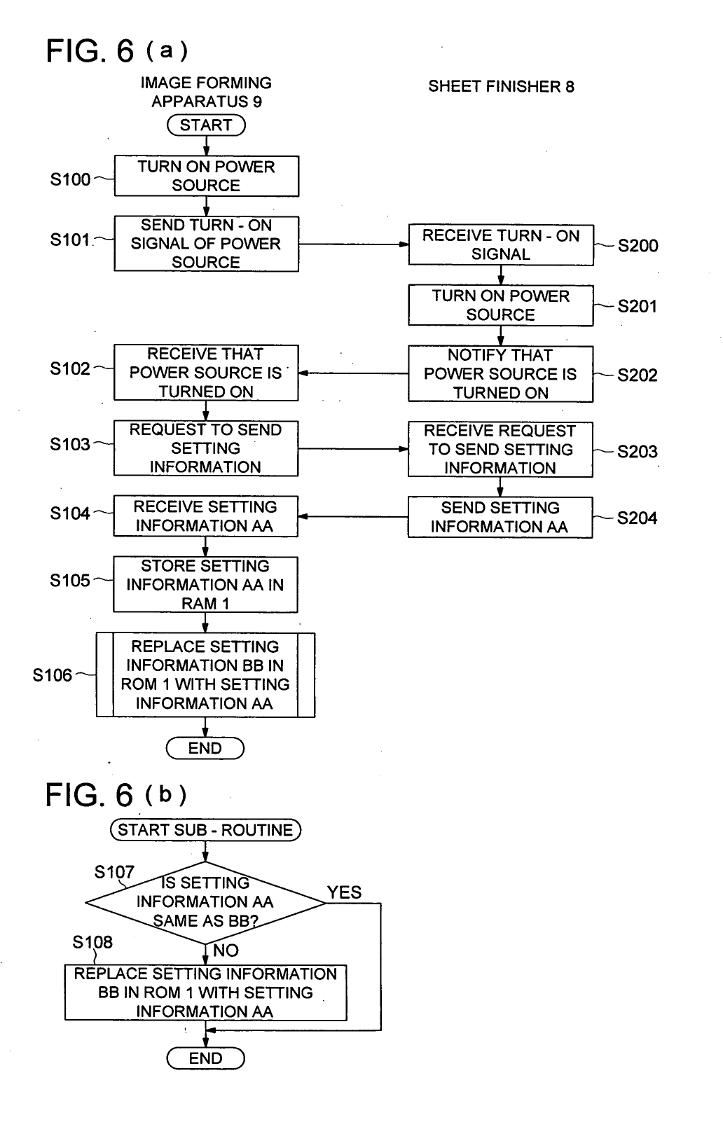

FIG. 5 is a block diagram of an example of image forming system which contains image forming apparatus 1 connected to sheet finisher 8.

First, there will be explained the image forming apparatus. Controller A of image forming apparatus 1 is equipped with CPU-1, ROM1 which stores a program to control the whole image formation, a communication control method, etc., RAM1, and communication section C1 to communicate with the sheet finisher. Controller A is connected to operation panel 10, automatic document feeder 2, image reader 3, sheet feeding section D, image forming section 4, conveyance section 5, sheet ejection section 6 and reverse conveyance section 7.

Controller A reads the image formation control program from ROM1, controls automatic document feeder 2, image reader 3, sheet feeding section D, image forming section 4, conveyance section 5, sheet ejection section 6 and reverse conveyance section 7 according to the job-related information such as a sheet size, the number of sheets to be processed, and a sheet finishing type, forms images on sheets, and ejects the processed sheets to the sheet finisher.

Further, controller A reads a communication control method and related information from ROM1. When job-related information such as a sheet size, the number of sheets to be processed, and a sheet finishing type is entered from operation panel 10, controller A sends the job-related information to controller B of sheet finisher 8 via communication sections C1 and C2.

Next, there will be explained sheet finisher 8. Controller B of sheet finisher 8 is equipped with CPU-2, ROM2 which stores a program to control the whole sheet finishing, a communication control method, and setting information of the sheet finisher, RAM2, and communication section C2 to communicate with the image forming apparatus. Controller B is connected to center-folding unit 71, first conveyance section 72, center-stapling section 73, second conveyance section 74, third conveyance section 75, cutting section 76, stacking section 77, and switching sections 700 and 703.

Controller B reads the sheet finishing control program from ROM2, and controls center-folding unit 71, first conveyance section 72, center-stapling section 73, second conveyance section 74, third conveyance section 75, cutting section 76, stacking section 77, tray 79, and switching sections 700 and 703 to finish sheets, for example, to form booklets.

When receiving a request that was sent from communication section C1 to send setting information of the sheet finisher via communication section C2, controller B reads setting information from ROM2 and sends the setting information to controller A of image forming apparatus 1 via communication sections C2 and C1.

With this, image forming apparatus 1 can acquire setting information of sheet finisher 8 even when image forming apparatus 1 retains no setting information of sheet finisher 8 in advance.

Each of FIGS. 6(a)-6(b) shows an example of control flow of an image forming system which contains image forming apparatus 1 connected to sheet finisher 8.

Referring to FIG. 6(a), below, there will be explained a method of connecting new sheet finisher 8 to image forming apparatus 1 which has no setting information of the sheet finisher 8, causing the new sheet finisher 8 to send its setting information to image forming apparatus 1, and controlling image forming apparatus 1 by the setting information of the sheet finisher 8. The following control is implemented by controller A of image forming apparatus 1 and controller B of the sheet finisher via communication sections C1 and C2.

When image forming apparatus 1 is powered on (Step S100), controller A sends a power ON signal to controller B of sheet finisher 8 to turn on sheet finisher 8 (Step S200). Controller B turns on power of sheet finisher 8 by a logical switch (Step S201). Controller B notifies controller A of that sheet finisher 8 is powered on (Step S202). When notified, controller A recognizes that sheet finisher 8 is ready to communicate with controller A (Step S102). Controller A requests controller B to send setting information of sheet finisher 8 (Step S103).

Usually, a sheet finisher is connected to the image forming apparatus when power is turned off. In this case, the operator may forget acquiring setting information and the image forming apparatus may not work with the sheet finisher. In this invention, to prevent this, it is when the image forming apparatus is powered on that the image forming apparatus acquires setting information of sheet finisher 8 which is connected to the image forming apparatus.

In some cases, however, sheet finisher 8 is connected to the image forming apparatus while they are powered on. Therefore, it is also possible to make a send request when their connection is detected or when a command is entered from the operation panel.

Controller B receives a request to send setting information of the sheet finisher (Step S203). Upon receiving the request, controller B sends setting information AA of sheet finisher 8 which has been stored from ROM2, to controller A (Step S204).

Controller A receives setting information AA of the sheet finisher (Step S104), temporarily stores it in RAM1 (Step S105), and rewrites the currently stored setting information BB in ROM1 by just-received setting information AA of the sheet finisher (Step S106).

With this, image forming apparatus 1 can use new setting information AA of sheet finisher 8 to control the sheet finisher. In other words, the cooperation of image forming apparatus 1 and sheet finisher 8 is enabled.

If the setting information is the same as what is stored in ROM1, step S106 can be omitted and the next subroutine as shown in FIG. 6(b) can be used because the content of ROM1 need not be rewritten.

Next, in FIG. 6(b), setting information BB which is currently stored in ROM1 is compared by setting information AA stored in RAM1 for identity (Step S107). If they are not identical (NO), the setting information of the sheet finisher in ROM1 is different and required to be changed. Setting information BB in ROM1 is rewritten with setting information AA which is received (Step S108). When they are identical (YES), setting information BB in ROM1 is left unwritten and the step is finished.

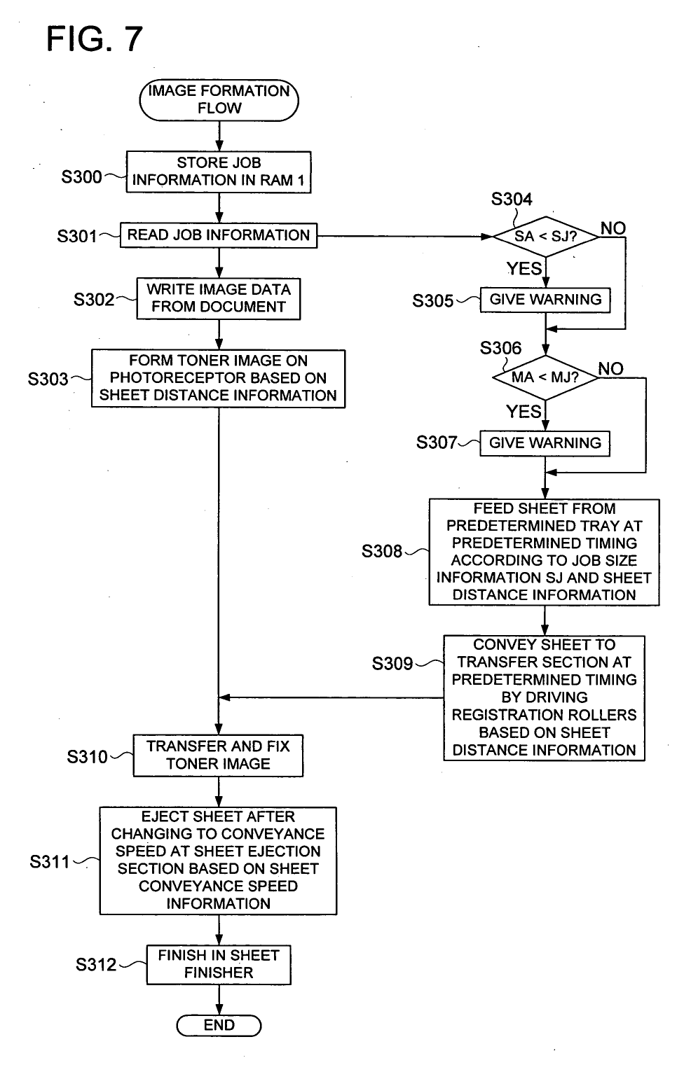

FIG. 7 shows an example of control flow using setting information of sheet finisher 8 in image forming apparatus 1.

Below, there will be explained how setting information AA of the sheet finisher is used for processing in image forming apparatus 1. The following control is implemented by controller A of image forming apparatus 1 and controller B of the sheet finisher.

In FIG. 7, the setting information of the sheet finisher contains sheet distance information DA, conveyance speed information VA, information of maximum number of sheets to be processed MA, and information of maximum sheet size SA. The job-related information that the operator enters from the operation panel contains job-specified size information SJ and information of the number of sheets to be processed for one job MJ.

In the above-described flow, image forming apparatus 1 acquires setting information AA of sheet finisher 8 and starts image formation.

The following control is implemented by controller A of image forming apparatus 1.

Job-related information entered by the operator from operation panel 10 or the like is temporarily stored in RAM1 (Step S300). Then, the job-related information is read from RAM1 (Step S301).

On one hand, controller A controls automatic document feeder 2 and image reader 3 according to the job information to read image information of a document and stores the read image data in memory GM (Step S302). After performing various kinds of image processing on the stored image data, controller A controls operation of drives such as laser writer 33 in image forming section 4 at a timing specified by the sheet distance information to form a toner image corresponding to the image data on photoreceptor 31 (Step S303).

One the other hand, controller A compares information of maximum sheet size SA in setting information AA of the sheet finisher with job-specified size information SJ in the job information (Step S304). If SJ is greater than SA (YES), controller A outputs an alarm relating to abnormal setting and a re-setting prompting message to the operation panel 10 or the like because sheet finisher 8 cannot perform sheet finishing with that setting (Step S305). If SJ is smaller than or equal to SA (NO), control is transferred to Step S306.

Next, controller A compares information of maximum number of sheets to be processed MA with information of the number of sheets to be processed for one job MJ (Steps S306 and S307). If MJ is greater than MA (YES), sheets cannot be stacked on the identical tray for an identical job. Controller A outputs an alarm relating to abnormal setting and a re-setting prompting message to the operation panel 10 (Step S307).

If MJ is smaller than MA (NO), control is transferred to Step S308.

Next, a sheet is fed from a selected tray which stores sheets of a size specified by job size information SJ at a predetermined timing on the basis of the sheet distance information (Step S308).

The sheet is conveyed by conveyance rollers R6 until its leading edge hits registration roller 46 which is stopped, thereby skew thereof is corrected and stops there. At a predetermined timing according to the sheet distance information, registration roller 46 is driven to deliver the sheet to the transfer section (Step S309).

In the transfer section, a toner image formed on photoreceptor 31 is transferred to the delivered sheet by transfer electrode 35. The image-transferred sheet is fixed by fixing device 39 and ejected by ejection rollers 51 (Step S310).

The fixed sheet is ejected to the sheet finisher at a sheet conveyance speed of the sheet finisher which is changed by the conveyance speed information in sheet ejection section 6 (Step S311).

The sheet conveyance speed is changed to the sheet conveyance speed of the sheet finisher in sheet ejection section 6 according to the conveyance speed information as follows. In sheet ejection section 6, the fixed sheet is guided downward and conveyed toward reverse rollers 55 by switching member 52. The sheet is delivered toward reverse rollers 55 at a process speed fit for image formation. After the leading edge of the sheet passes through the clearance between reverse rollers 55, the sheet temporarily stops with its trailing edge clamped by the rollers. Then, the sheet conveyance speed is changed to the conveyance speed of the sheet finisher according to the conveyance speed information. The reverse rollers are turned backwards to reverse the sheet and send it towards sheet ejection roller 53. The sheet ejection rollers 53 are driven at the conveyance speed of the sheet finisher according to the conveyance speed information. The sheet is delivered at this sheet conveyance speed toward sheet finisher 8.

After receiving the sheet from image forming apparatus 1, sheet finisher 8 finishes the sheet as follows (S312).

Although the sheet-is reversed and ejected in the above example, it is also possible to guide the sheet upwards by switching member 52 and eject the sheet without reversing it. In this case, the sheet conveyance speed of sheet ejection roller 53 is changed from the sheet conveyance speed fit for image formation to the sheet conveyance speed of the sheet finisher according to the conveyance speed information immediately after the trailing end of the sheet passes through fixing ejection rollers 51. Thus, the sheet can be ejected toward the sheet finisher at the sheet conveyance speed of the sheet finisher.

In the above description, the image formation uses, as the setting information of the sheet finisher, the sheet distance information, the conveyance speed information, the information of maximum number of sheets to be processed, and the information of maximum sheet size.

The above example is explained using a monochromatic image forming apparatus. However, it is possible to build up a color image forming system using the similar configuration with a sheet finisher.

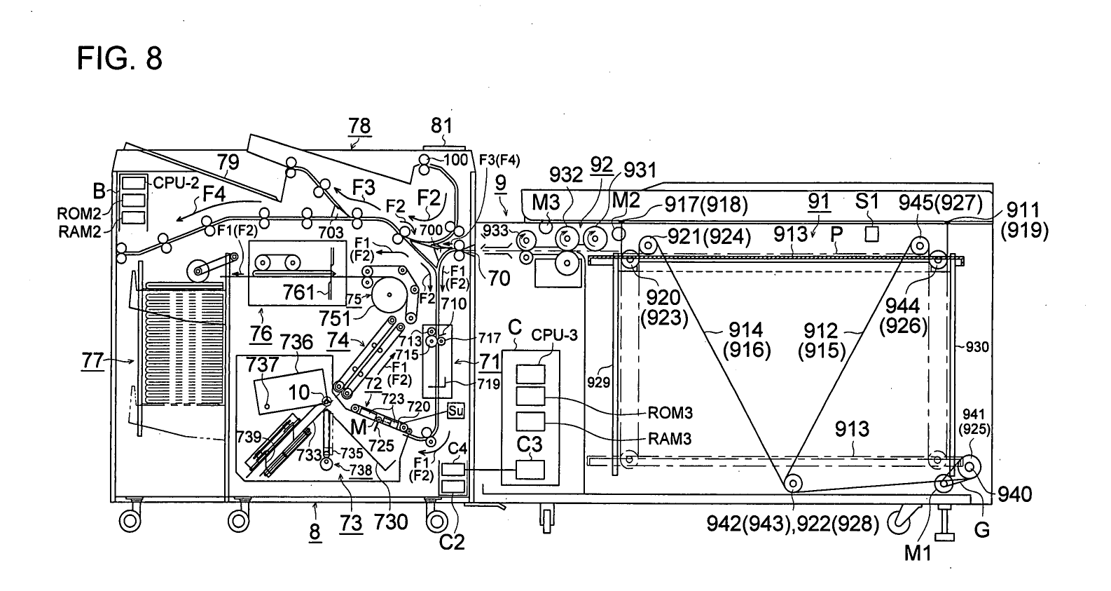

FIG. 8 is an explanatory view of an example of a sheet finishing system in which sheet feeding device 9 is connected to sheet finisher 8.

Below, there will be explained a sheet finishing system in which sheet feeding device 9 and sheet finisher 8 are connected to feed sheets from sheet feeding device 9 to sheet finisher 8 for sheet finishing.

Sheet feeding device 9 and sheet finisher 8 of FIG. 8 are the same as those of FIG. 2 and FIG. 3 and their detailed explanation is omitted here.

Sheet feeding device 9 and sheet finisher 8 are connected to perform the above-explained sheet feeding and finishing operations. Sheet finisher 8 receives sheets from sheet feeding device 9 and performs predetermined sheet finishing on the sheets.

When receiving job-related information such as a sheet size, the number of sheets to be processed, and a sheet finishing type from operation panel 81 of sheet finisher 8, controller B performs sheet finishing due to job-related information, for example, positions stopper 719 for a selected sheet size, loads and stops loading the requested number of sheets on tray 79 and stacking section 77 when the number of sheets reaches the requested number of sheets, changes sheet paths F1, F2, F3, and F4 by switching section 700 according to the specified sheet finishing type, and turns on or off center-folding unit 71, center-stapling section 73 and cutting section 76 to perform the specified sheet finishing.

Further, for example, when sheet feeding device 9 is powered on, controller C of sheet feeding device 9 sends a request to send setting information of sheet finisher 8 to controller B of sheet finisher 8 via communication sections C3 and C4. Controller B sends the setting information of sheet finisher 8 to controller C via communication sections C4 and C3. When receiving the setting information of sheet finisher 8, the sheet feeding device 9 acquires the setting information of sheet finisher 8.

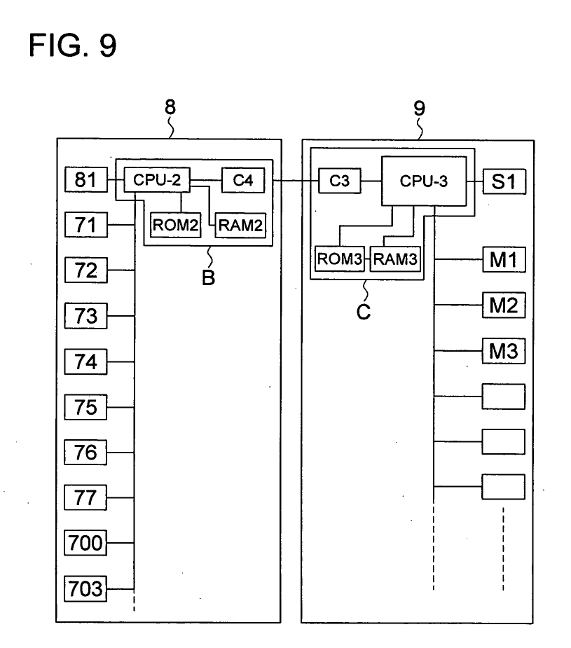

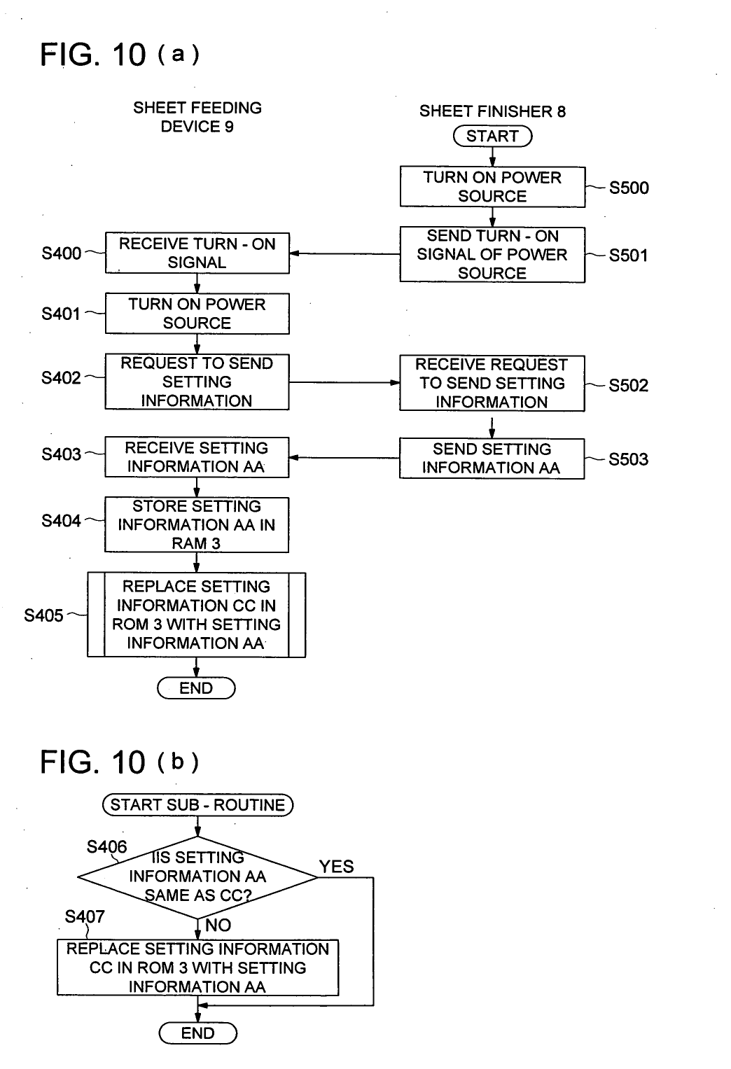

FIG. 9 is a block diagram of an example of sheet finishing system in which sheet feeding device 9 is connected to sheet finisher 8.

Since sheet finisher 8 is already explained, sheet feeding device 9 and only different functions of sheet finisher 8 will be explained here.

Controller C of sheet feeding device 9 is equipped with CPU-3, ROM3 which stores a program to control the whole sheet feeding operation and information about a communication control method, RAM3, and communication section C3. To controller C, there are connected sensor S1 to detect a sheet position on the sheet stacking table, motor M1 to move the sheet stacking table, motor M2 to drive the sheet feeding rollers, and motor M3 to drive registration rollers and sheet ejection rollers to deliver sheets to the sheet outlet.

Controller C reads the program to control the whole sheet feeding operation from ROM3 and controls motor M1 to adjust the sheet top position on the sheet stacking table, motor M2 to feed sheets one by one, and motor M3 to deliver the sheet to the sheet finisher.

Controller C reads information of the communication control method and the like from ROM3, communicates with controller B of sheet finisher 8 via communication sections C3 and C4, requests controller B to send setting information of the sheet finisher, and receives the setting information of the sheet finisher.

Controller B of sheet finisher 8 controls center-folding unit 71, first conveyance section 72, center-stapling section 73, second conveyance section 74, third conveyance section 75, cutting section 76, stacking section 77, tray 79, and switching sections 700 and 703 according to job-related information entered from operation panel 81, for example, sheet size, number-of sheets, and sheet finishing type, to form for example a booklet. At the start of sheet finishing, controller B sends job-related information to controller C of sheet feeding device 9 via communication sections C4 and C3.

When receiving a request to send the setting information of the sheet finisher from controller C, controller B reads the sheet finisher setting information from ROM2, and sends the information to controller C via communication sections C4 and C3.

With this, sheet feeding device 9 can acquire setting information of sheet finisher 8 even when sheet feeding device 9 retains no setting information of sheet finisher 8 in advance.

Each of FIGS. 10(a)- 10(b) shows an example of control flow of a sheet finishing system in which a sheet feeding device is connected to the sheet finisher.

Referring to FIG. 9 and FIGS. 10(a)- 10(b), there will be explained below a method of controlling sheet feeding device 9 according to setting information of new sheet finisher 8 which is connected to sheet feeding device 9 after new sheet finisher 8 is connected to sheet feeding device 9 which does not have any setting information of the new sheet finisher 8, wherein sheet feeding device 9 receives setting information of the new sheet finisher 8 and controls itself 9 according to the setting information. The following control is implemented by controller C of sheet feeding device 9 and controller B of sheet finisher 8 via communication section C3 and C4.

When sheet finisher 1 is powered on (Step S500), controller B sends a power ON signal to controller C of sheet feeding device 9 to turn on power (Step S501). Controller C turns on power of sheet feeding device 9 by a logical switch (Step S401). It is also possible to turn on power by turning on sheet feeding device 9, sending a power ON signal to the sheet finisher, and turning on the sheet finisher by this signal. Then, controller C requests controller B to send setting information of sheet finisher 8 (Step S402).

Usually, sheet feeding device 9 is connected to sheet finisher 8 while power is off. In this case, however, the operator may forget acquiring setting information and the sheet feeding-device may not work with the sheet finisher. In this invention, to prevent this, it is when sheet feeding device 9 is powered on that the sheet feeding device acquires setting information of sheet finisher 8 which is connected to the image forming apparatus.

In some cases, however, sheet feeding device 9 is connected to sheet finisher 8 while they are powered on. Therefore, it is also possible to make a send request when their connection is detected or when a command is entered from the operation panel.

Controller B receives a request to send setting information of the sheet finisher (Step S502). Upon receiving the request, controller B sends setting information AA of sheet finisher 8 which has been stored from ROM2 to controller C of sheet feeding device 9 (Step S503).

Controller C receives setting information AA of the sheet finisher (Step S403), temporarily stores it in RAM3 (Step S404), and rewrites the content of setting information CC in ROM3 by just-received setting information AA of the sheet finisher (Step S405).

With this, sheet feeding device 9 can use new setting information AA of sheet finisher 8 to control thereof. In other words, the cooperation of sheet feeding device 9 and sheet finisher 8 is enabled.

If the setting information is the same as what is stored in ROM3, step S405 can be omitted and the next subroutine as shown in FIG. 10(b) can be used because the content of ROM3 need not be rewritten.

Next, in FIG. 10(b), setting information CC which is currently stored in ROM3 is compared with setting information AA in RAM3 for identity (Step S406). If they are not identical (NO), the setting information of the sheet finisher in ROM3 is different and required to be changed. Setting information CC in ROM3 is rewritten with setting information AA which is received (Step S407). When they are identical (YES), setting information CC in ROM3 is left unwritten and the step is finished.

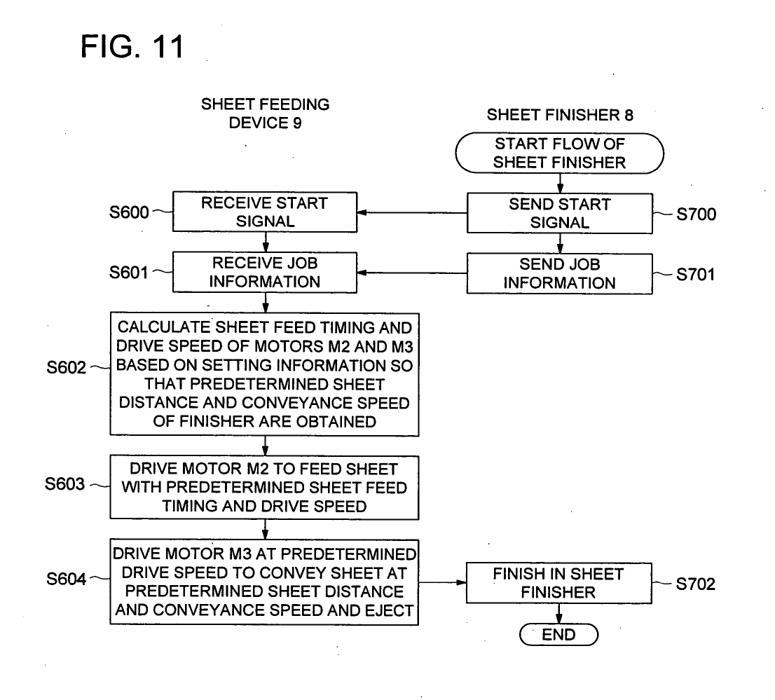

FIG. 11 shows a control flow of sheet feeding device 9 according to setting information of the sheet finisher.

Below, there will be explained processing of sheet feeding device 9 according to setting information AA of the sheet finisher. The following control is implemented by controller C of sheet feeding device 9. The following example assumes that a series of processing starts at sheet finisher 8.

When the operator presses the START button on sheet finisher 8, a sheet finishing operation starts. Controller B of sheet finisher B first sends a START signal to controller C of sheet feeding device 9 (Step S700) and then job-related information, for example, number of sheets to be finished, number of copies, and sheet finishing type, to controller C. Controller C receives the START signal (Step S600) and job-related information in sequence (Step S601).

At Step S405 in the flow, controller C controls the components of sheet feeding device 9 according to new setting information AA of the sheet finisher which was received from sheet finisher 8.

First, a sheet feeding timing and speeds of motors M2 and M3 are calculated to obtain a predetermined sheet distance and a predetermined sheet conveyance speed of the sheet finisher according to setting information AA (Step S602). Motor M2 is driven at the calculated sheet feeding timing and driving speed. This causes sheet feeding roller 931 to rotate and deliver sheets one by one from the sheet stack (Step S603). The sheets are delivered at a predetermined sheet distance and the sheet conveyance speed of the sheet finisher according to setting information AA of the sheet finisher by registration rollers 932 and sheet ejection rollers 933 which are driven by motor M3 which runs at a calculated speed (Step S604). Sheet finisher 8 receives the sheets from sheet feeding device 9 and performs a predetermined sheet finishing on the sheets. With this, a series of processing flow is completed (Step S703).

The above configuration which adjusts the sheet conveyance speed of sheets delivered from sheet feeding device 9 to the sheet conveyance speed of sheet finisher 8 can eliminate a difference in sheet conveyance timing between sheet feeding device 9 and sheet finisher 8 and prevent occurrence of sheet jamming.

This invention can provide the following effects.

(1) The image forming system does not require installation of a new control software even when sheet information of the sheet finisher has not been stored in the image forming system or when the sheet finisher and the image forming apparatus have different sheet conveyance speeds and manual input of sheet information of the sheet finisher by the operator after the sheet finisher is connected to the image forming apparatus.

This invention can provide an image forming apparatus and an image forming system which can quickly run together without being apprehensive that a memory medium may be lost.

(2) The above control method is to control sheet feeding intervals by adjusting image formation timing in the image forming section and sheet feeding timing in the sheet feeding section and to equalize sheet conveyance speeds of the image forming apparatus and the sheet finisher. With this control, sheets can be delivered from the image forming apparatus smoothly to the sheet finisher without any difference in sheet conveyance speeds of the mage forming apparatus and the sheet finisher. This can prevent occurrence of sheet jamming due to improper sheet conveyance timing.

(3) The image forming apparatus can always acquire setting information of the sheet finisher when the image forming apparatus requires it.

(4) The sheet-related information contains information of a maximum number of sheets to be processed by the sheet finisher and information of maximum sheet size to be processed. With this, the image forming apparatus can recognize requirements of the sheet finisher such as sheet capacity and sheet size limitation of the sheet finisher.

(5) Abnormal settings can be detected by collected information about the maximum number of sheets that can be processed and specified information about the number of sheets requested. This can prevent system failures due to abnormal settings.

(6) This invention can provide a sheet feeding device and a sheet finishing system which do not require installation of a new control software even when sheet information of the sheet finisher has not been stored in the sheet feeding device or when the sheet finisher and the sheet feeding device have different sheet conveyance speeds and manual input of sheet information of the sheet finisher by the operator after the sheet finisher is connected to the sheet feeding device.

The sheet feeding device and the sheet finisher can quickly run together without being apprehensive that a memory medium may be lost.

(7) The control method of the sheet conveying section is to control sheet feeding intervals by adjusting sheet feeding timing in the sheet conveying section and to equalize the sheet conveyance speed of the sheet feeding section to the sheet conveyance speed of the sheet finisher. With this control, sheets can be delivered from the sheet feeding section smoothly to the sheet finisher without any difference in sheet conveyance speeds of the sheet feeding section and the sheet finisher. This can prevent occurrence of sheet jamming due to improper sheet conveyance timing.

What is claimed is:

1. An image forming apparatus comprising:
(a) an image forming section which forms an image therein;
(b) a sheet feeding section which feeds a sheet to the image forming section;
(c) a sheet ejection section which ejects the sheet to a sheet finisher to be connected with the image forming apparatus;
(d) a communication section which communicates with the sheet finisher; and
(e) a controller which controls the communication section and the sheet feeding section,
wherein the controller controls the communication section, the sheet feeding section and the sheet ejection section on the basis of setting information with respect to information on a sheet distance between a preceding sheet and a following sheet thereof and information on a sheet conveyance speed which has been stored in the sheet finisher and is received from the sheet finisher through the communication section.

2. The image forming apparatus of claim 1, wherein the controller controls the sheet distance by controlling an image forming timing in the image forming section and a sheet feeding timing in the sheet feeding section, and controls to change a sheet conveyance speed at the sheet ejection section to the sheet conveyance speed in the sheet finisher.

3. The image forming apparatus of claim 1, wherein the controller controls the communication section to send a request of the setting information and to receive the setting information on the basis of the request to send.

4. The image forming apparatus of claim 1, wherein the setting information includes information on a maximum sheet size and a maximum quantity of sheet capable of being processed.

5. The image forming apparatus of claim 4, wherein the controller detects an abnormal setting on the basis of the information on the maximum quantity of sheet capable of being processed which is received, and the number of sheets requested to be processed which is set.

6. The image forming apparatus of claim 4, wherein the controller warns an abnormal setting on the basis of the information on the maximum quantity of sheet capable of being processed which is received, and the number of sheets requested to be processed which is set.

7. The image forming apparatus of claim 4, wherein the controller detects an abnormal setting on the basis of the information on the maximum size of sheet capable of being processed which is received, and a sheet size which is set.

8. The image forming apparatus of claim 4, wherein the controller warns an abnormal setting on the basis of the information on the maximum size of sheet capable of being processed which is received, and a sheet size which is set.

9. An image forming system comprising:
(a) an image forming apparatus which forms an image on a sheet; and
(b) a sheet finisher which finishes the sheet on which the image has been formed by the image forming apparatus,
the image forming apparatus comprising:
(1) an image forming section which forms an image therein;
(2) a sheet feeding section which feeds a sheet to the image forming section;
(3) a sheet ejection section which ejects the sheet to a sheet finisher to be connected with the image forming apparatus;
(4) a first communication section which communicates with the sheet finisher; and
(5) a controller which controls the communication section and the sheet feeding section; and
the sheet finisher comprising:
a second communication section which communicates with the image forming apparatus and has setting information to control the sheet finisher,
wherein the controller controls the communication section, the sheet feeding section and the sheet ejection section on the basis of setting information with respect to information on a sheet distance between a preceding sheet and a following sheet thereof and information on a sheet conveyance speed which has been stored in the sheet finisher and is received from the second communication section of the sheet finisher through the first communication section.

10. The image forming system of claim 9, wherein the controller controls the sheet distance by controlling an image forming timing in the image forming section and a sheet feeding timing in the sheet feeding section, and controls to change a sheet conveyance speed at the sheet ejection section to the sheet conveyance speed in the sheet finisher.

11. The image forming apparatus of claim 9, wherein the controller controls the communication section to send a request of the setting information and to receive the setting information on the basis of the request to send.

12. The image forming apparatus of claim 9, wherein the setting information includes information on a maximum sheet size and a maximum quantity of sheet capable of being processed.

13. The image forming apparatus of claim 12, wherein the controller detects an abnormal setting on the basis of the information on the maximum quantity of sheet capable of being processed which is received, and the number of sheets requested to be processed which is set.

14. The image forming apparatus of claim 12, wherein the controller warns an abnormal setting on the basis of the information on the maximum quantity of sheet capable of being processed which is received, and the number of sheets requested to be processed which is set.

15. The image forming apparatus of claim 12, wherein the controller detects an abnormal setting on the basis of the information on the maximum size of sheet capable of being processed which is received, and a sheet size which is set.

16. The image forming apparatus of claim 12, wherein the controller warns an abnormal setting on the basis of the information on the maximum size of sheet capable of being processed which is received, and a sheet size which is set.

17. A sheet feeding device comprising:
(a) a stacking section on which a sheet is stacked;
(b) a sheet feeding roller which feeds the sheet one by one from the stacking section;
(c) a conveyance section which conveys the sheet to a sheet finisher connected with the sheet feeding device;
(d) a communication section which receives setting information relating to a sheet in the sheet finisher; and
(e) a controller which controls the sheet feeding device,
wherein the controller controls the conveyance section on the basis of the setting information with respect to information on a sheet distance between a preceding sheet and a following sheet thereof, and information on a sheet conveyance speed which is received from the sheet finisher and has been stored therein.

18. The sheet feeding device of claim 17, wherein the controller controls a sheet feeding timing in the sheet feeding section, and controls to change a sheet conveyance speed in the sheet conveyance section to the sheet conveyance speed in the sheet finisher.

19. A sheet finishing system comprising:
(a) a sheet feeding device which feeds a sheet; and
(b) a sheet finisher which finishes the sheet fed from the sheet feeding device,
the sheet feeding device comprising:
(1) a stacking section on which a sheet is stacked;
(2) a sheet feeding roller which feeds the sheet on e by one from the stacking section;
(3) a conveyance section which conveys the sheet to a sheet finisher connected with the sheet feeding device;
(4) a communication section which receives setting information relating to a sheet in the sheet finisher; and
(5) a controller which controls the sheet feeding device,
wherein the controller controls the conveyance section on the basis of the setting information with respect to information of a sheet distance between a preceding sheet and a following sheet thereof, and sheet conveyance speed information which is received from the sheet finisher and has been stored therein.

20. The sheet finishing system of claim 19, wherein the controller controls a sheet feeding timing in the sheet feeding section, and controls to change a sheet conveyance speed in the sheet conveyance section to the sheet conveyance speed in the sheet finisher.
